(19) United States
(12) Patent Application Publication
(10) Pub. No.: US 2007/0195367 A1
(43) Pub. Date: Aug. 23, 2007

(54) Computer readable medium recording a printer control program, printer control method, and printer system

(75) Inventors: Toshihiro Kumagai, Shiojinshi (JP); Kiyotaka Nishimura, Matsumoto-shi (JP); Norihiko Nakajima, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/710,308

(22) Filed: Feb. 22, 2007

(30) Foreign Application Priority Data
Feb. 22, 2006 (JP) 2006-45432
Sep. 15, 2006 (JP) 2006-251303

(51) Int. Cl. G06K 15/00

(52) U.S. Cl. 358/1.16

(57) ABSTRACT

The present invention provides a computer readable medium recording a printer control program for executing in a computer a command generation of generating a command that instructs a printer on operation and a command transmission of converting a command containing a predetermined amount of data into a packet and transmitting the packet command, wherein the computer executes: generating a preprocessing command for actuating a printing mechanism before a coloring agent is attached to a printing medium, and generating a dummy command to be included in a packet so as to obtain the predetermined amount of data, which will be discarded by the printer, and generating one or more packets including the dummy command and the preprocessing command.

### CROSS-REFERENCE TO RELATED APPLICATIONS

This application is based upon and claims the benefit of priority from the prior Japanese Patent Application No. 2006-045432, filed on Feb. 22, 2006, and the prior Japanese Patent Application No. 2006-251303, filed on Sep. 15, 2006 the entire contents of which are incorporated herein by reference.

### BACKGROUND OF THE INVENTION

1. Field of the Invention

The present invention relates to a computer readable medium recording a printer control program installed on a printer host for controlling a printer, to a method for controlling the printer, and to a printer system comprising the printer.

2. Description of the Related Art

The conventional technology for transferring data between a printer host and a printer is disclosed in Japanese Patent Laid-open No. 11-188953.

In asynchronous communication in which a packet containing any amount of data is transmitted to a printer from a printer host at a random timing, printing is not started before all the data of a page unit are received. For this reason, the aforementioned patent application suggested isochronous communication in which a packet containing a predetermined amount of data is transmitted to a printer. Furthermore, this publication discloses a technology by which when the printing data almost overrun in response to a communication state, dummy data are included in a packet from a printer host and the printing state and communication state are balanced.

### SUMMARY OF THE INVENTION

Although the above-described publication discloses the conventional technology for activating a printer as fast as possible after receiving a printing start command with a printer host, the fact is that users strongly demand that the printers operate even faster.

With this demand in view, it is an object of the present invention to provide a computer readable medium recording a printer control program, a control method for a printer, and a printer system comprising a printer that can rapidly actuate the printer.

The present invention that relates to a computer readable medium recording a printer control program for attaining this object provides a computer readable medium recording a printer control program for executing in a computer a command generation of generating a command that instructs a printer on operation and a command transmission of converting a command containing a predetermined amount of data into a packet and transmitting the packet command, wherein

a preprocessing command generation of generating a preprocessing command for actuating a printing mechanism before a coloring agent is attached to a printing medium in the course of a printing step in the printing mechanism of the printer and outputting the preprocessing command, and

a dummy command generation of generating a dummy command with a command length of from 1 byte to the packet length that will be discarded by the printer and outputting the dummy command subsequently to the preprocessing command if the preprocessing command is outputted in the preprocessing command generation

are executed in the command generation, and

the dummy command is added to the preprocessing command to obtain a packet so as to obtain the data of the predetermined amount in the command transmission.

In accordance with the present invention, when a printing instruction is received and a command corresponding to this printing instruction is converted into a packet and transmitted to a printer, a dummy command is outputted subsequent to a preprocessing command that precedes a printing data command. Therefore, if the preprocessing command is outputted, the amount of data contained in the packet almost simultaneously becomes the predetermined amount of data, and the packet containing the preprocessing command is immediately outputted to the printer. As a result, in accordance with the present invention, the interval from the reception of printing instruction to the start of printing operation can be shortened.

The present invention that relates to a printer control method for attaining this object provides a printer control method having a command generation of generating a command that instructs a printer on operation and a command transmission of converting a command containing a predetermined amount of data into a packet and transmitting the packet command, wherein

a preprocessing command generation of generating a preprocessing command for actuating a printing mechanism before a coloring agent is attached to a printing medium in the course of a printing step in the printing mechanism of the printer and outputting the preprocessing command, and

a dummy command generation of generating a dummy command with a command length of from 1 byte to the packet length that will be discarded by the printer and outputting the dummy command subsequently to the preprocessing command if the preprocessing command is outputted in the preprocessing command generation

are executed in the command generation, and

the dummy command is added to the preprocessing command to obtain a packet so as to obtain the data of the predetermined amount in the command transmission.

The present invention that relates to a printer system for attaining this object provides a printer system having a printing unit and a control unit that controls the operation of the printing unit, wherein

the control unit has a command generation portion which generates a command that instructs the printing unit on operation, a storage region of a predetermined storage capacity which stores temporarily the command generated by the command generation portion, and a command transmission portion which converts a command containing the amount of data equivalent to the storage capacity into a packet and transmitting the packet command;

the printing unit has a command reception portion which receives a command from the printing unit, a control signal generation portion which interprets the command received by the command reception portion and generates a control signal corresponding to the interpretation results, and a printing mechanism which performs an operation in response to the control signal,

the command generation portion of the control unit has a preprocessing command generation portion which generates a preprocessing command that actuates the printing mechanism before a coloring agent is attached to a printing medium in the course of a printing step in the printing mechanism and outputting the preprocessing command to the storage region, and a dummy command generation portion which generates a dummy command with a command length of from 1 byte to the packet length that will be discarded by the printing unit and outputting the dummy command subsequently to the preprocessing command to the storage region if the preprocessing command generation portion generates the preprocessing command, and

the control signal generation portion of the printing unit discards the dummy command when the dummy command is contained in the command received by the command reception portion.

The present invention that relates to a command processing system that processes a command used for a printing unit comprising:

a command generation portion which generates the command that instructs the printing unit on operation;

a storage portion which stores the command generated by the command generation portion;

a command transmission portion which converts a command containing a predetermined amount of data into a packet and transmitting the packet command;

wherein the command generation portion has a preprocessing command generation portion which generates a preprocessing command that actuates a printing mechanism before a coloring agent is attached to a printing medium and outputting the preprocessing command to the storage portion, and a dummy command generation portion which generates a dummy command to be included in a packet so as to obtain the predetermined amount of data, which will be discarded by the printing unit and outputting the dummy command to the storage portion.

### BRIEF DESCRIPTION OF THE DRAWINGS

FIG. 1 is an explanatory drawing illustrating a hardware configuration of a printer system in an embodiment of the present invention;

FIG. 2 is an explanatory drawing illustrating a functional configuration of the printer system in the embodiment;

FIG. 3 is a perspective drawing of a printing mechanism in the embodiment;

FIGS. 4A1 to 4B2 are explanatory drawings illustrating the contents of a command row and packet row in the embodiment and a comparative example;

FIG. 5 is a flowchart illustrating the operation of the command generation unit in the embodiment;

FIG. 6 is a flowchart illustrating the operation of the command transmission unit in the embodiment;

FIG. 7 is a sequence diagram of the printer system in the embodiment; and

FIG. 8 is a sequence diagram of the printer system in a comparative example.

### DESCRIPTION OF THE PREFERRED EMBODIMENTS

An embodiment of the printer system in accordance with the present invention will be described below with reference to the appended drawings.

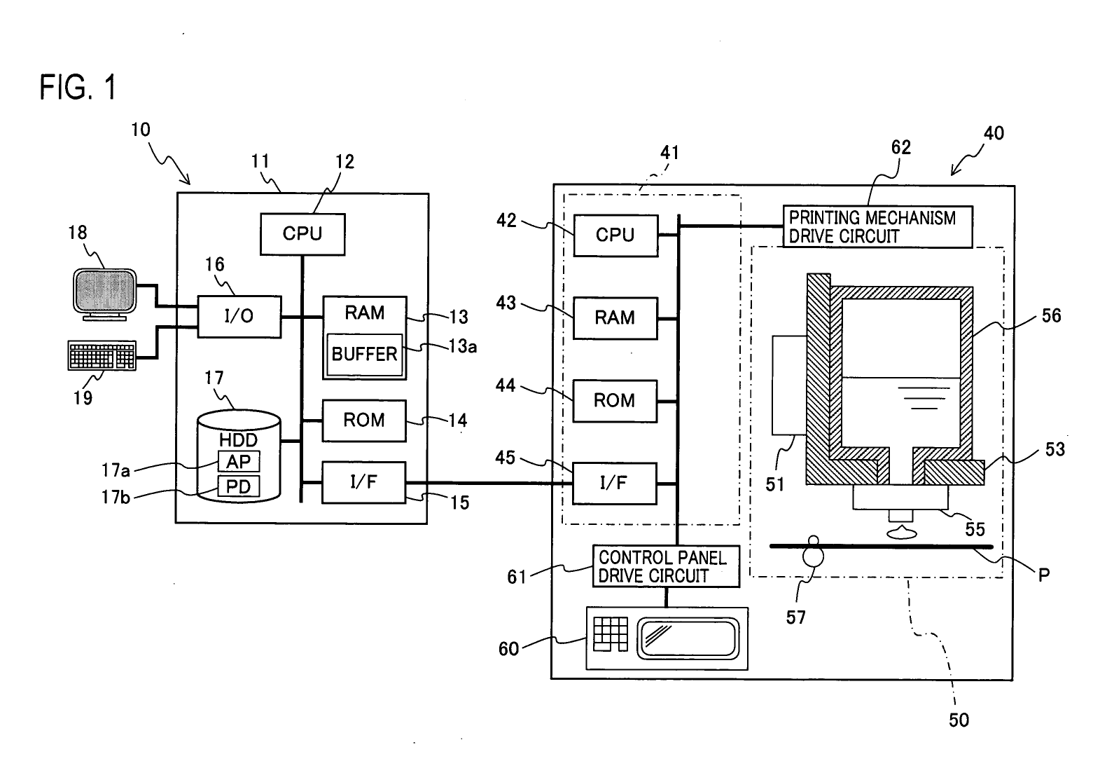

As shown in FIG. 1, the printer system of the present embodiment comprises a host computer 10 and an ink jet printer 40 controlled by the host computer 10.

The host computer 10 comprises a computer unit 11, an output device 18 such as a display, and an input device 19 such as a keyboard or mouse. The computer unit 11 has a CPU 12 for executing a variety of programs, a RAM 13 for temporarily storing a variety of data and programs, a ROM 14 that stores a variety of data or programs in advance, a communication interface circuit 15 for communicating with the printer 40, an I/O circuit 16 for controlling the output device 18 and input device 19, and an external storage device 17 such as a hard disk device. The external storage device 17 stores an application program 17a that creates data for printing and a printer driver 17b serving as a printer control program that controls the printer 40. Further, a buffer 13a that is a region for temporarily accumulating the commands that will be transmitted to the printer 40 is reserved in the RAM 13. In the present embodiment, the capacity of the buffer 13a is 64 KB. The printer driver may be installed on the host computer 10 from a CD or other recording media on which it is stored, or may be downloaded to the host computer 10 from a prescribed site via the Internet or another network.

The printer 40 comprises a controller 41, a printing mechanism 50 of an ink jet system, a printing mechanism drive circuit 62 for driving the printing mechanism, a control panel 60, and a control panel drive circuit 61 that drives the control panel. The controller 41 has a CPU 42 that executes a variety of programs, a RAM 43 that temporarily stores a variety of data, a ROM 44 that stores data or programs that will be executed by the CPU 42, and a communication interface circuit 45 for communication with the host computer 10. The components of the controller 41 are connected to each other with a bus.

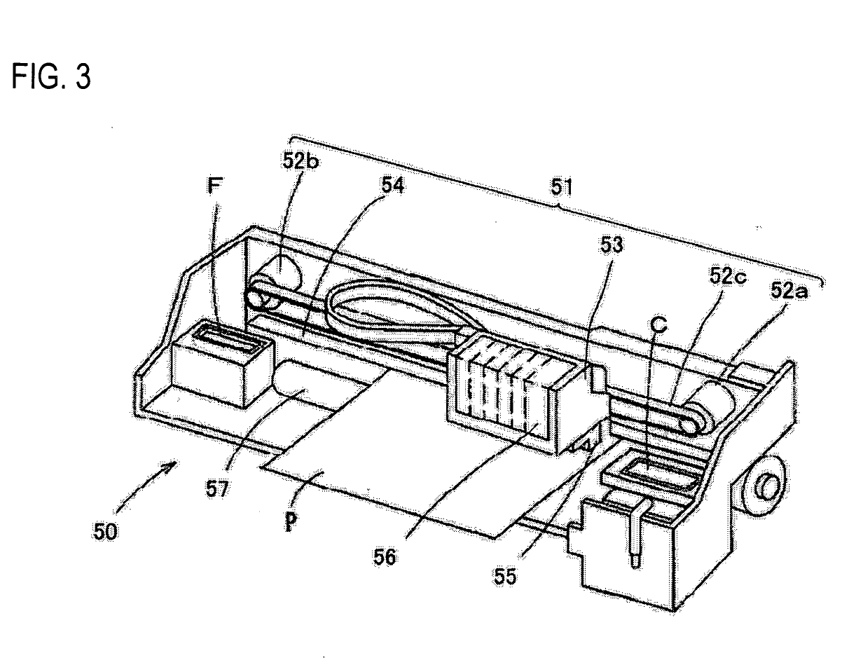

The printing mechanism 50 comprises ink cartridges 56 that accommodate individually the inks of various colors such as cyan, magenta, yellow, light cyan, light magenta, and black, a printing head 55 for discharging the ink located inside the ink cartridge 56 onto a printing paper P that is a printing medium, a carriage 51 for moving the printing head 55, and a conveying roller 57 for conveying the paper P. As shown in FIG. 3, the carriage 51 has a drive wheel 52a, a driven wheel 52b, a timing belt 52c stretched between the wheels 52a, 52b, a head base 53 having the printing head 55 provided thereon and also carrying the ink cartridges 56, and a guide 54 that controls the movement direction of the head base 53.

The printing mechanism 50 further comprises a flush region F formed in the vicinity of the left end of the guide 54 and a cap C formed in the vicinity of the right end of the guide 54. The flush region F is used for the so-called flushing operation in which ink droplets are ejected periodically or at the predetermined timing, regardless of the printing data, to prevent the ink from drying and solidifying at the distal end of the printing head 55. The flush region F is so provided as to be opposite the nozzle of the printing head 55 when the printing head 55 moves to the left end. For this purpose, when the flushing operation is performed, it is performed after the printing head 55 has moved to the left end. Furthermore, the cap C is used to seal a nozzle in order to prevent the nozzle of the printing head 55 from drying when the printing is not performed. This cap C covers the nozzle of the printing head 55 (cap is closed) when the printing ends and the printing head 55 moves to the right end (referred to as “home position”), and the cap is retracted from the printing head 55 (cap is opened) when the printing is started.

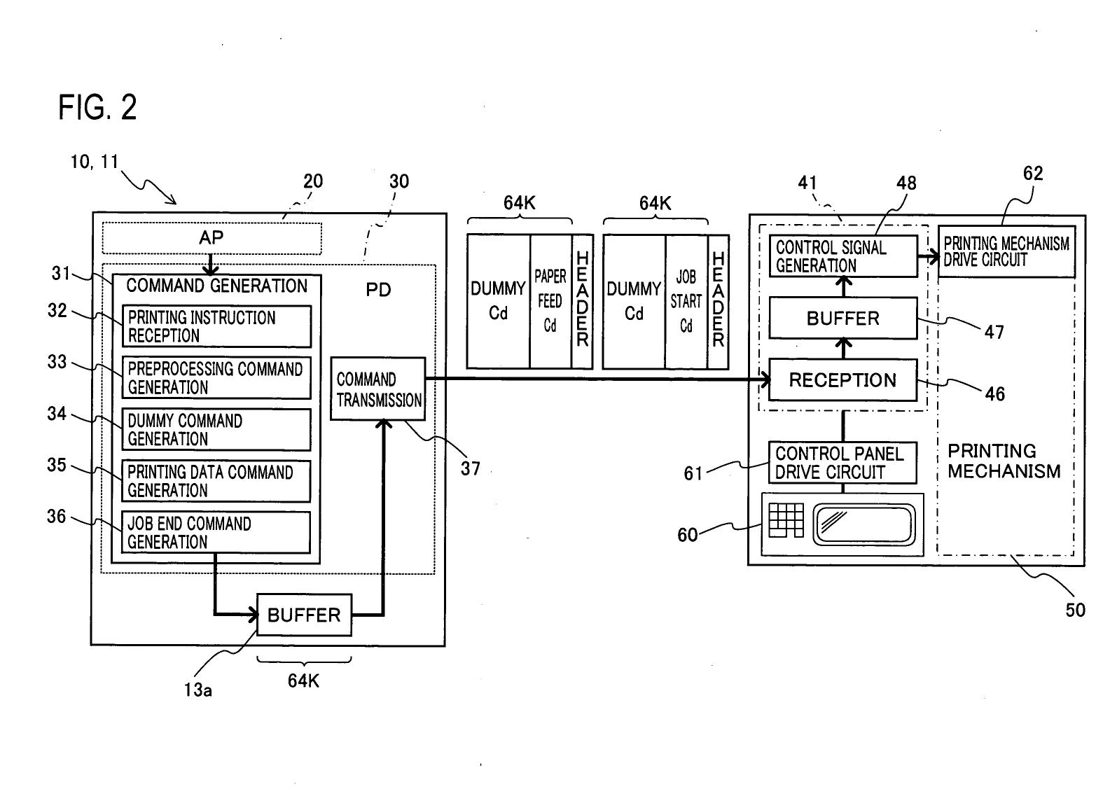

As shown in FIG. 2, functionally, the computer 11 of the host computer 10 has an AP unit 20 that functions when the aforementioned application program 17a is executed and a PD unit 30 that functions when the aforementioned printer driver 17b is executed. The PD unit 30 has a command generation unit 31 that receives a printing instruction from the AP unit 20 and generates a command to be transmitted to the printer 40 and a command transmission unit 37 that combines the command into a packet and transmits it to the printer 40. The command generation unit 31 has a printing instruction reception unit 32 that receives a printing command from the AP unit 20, a preprocessing command generation unit 33 that generates a preprocessing command of a job start command or paper feed command, a dummy command generation unit 34 that generates a dummy command, a printing data command generation unit 35 that generates a printing data command, and a job end command generation unit 36 that generates a job end command.

Functionally, the controller 41 of the printer 40 has a reception unit 46 hat receives a command from the host computer 10, a buffer 47 that temporarily stores the command received by the reception unit 46, and a control signal generation unit 48 that interprets the command and generates a control signal.

The operation of the above-described printer system will be described below.

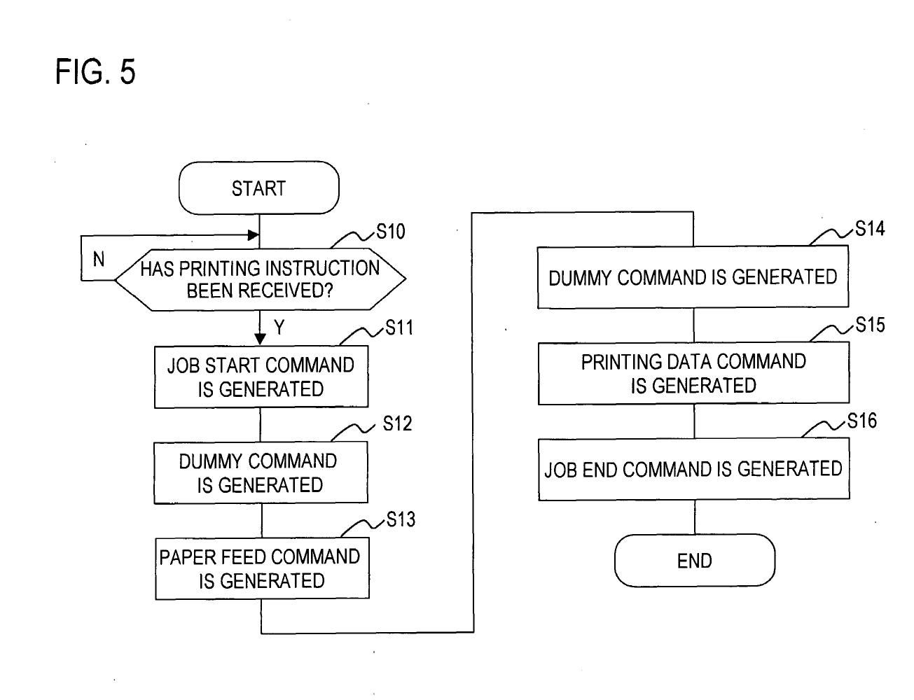

First, the operation of the command generation unit 31 of the host computer 10 will be described following the flowchart shown in FIG. 5.

If the printing instruction reception unit 32 of the command generation unit 31 receives a printing instruction from the AP unit 20 (S10), the preprocessing command generation unit 33 generates a job start command and transmits this command to the buffer 13a (S11). The dummy command generation unit 34 generates a dummy command, following the generation of this job start command and transmits the generated dummy command to the buffer 13a (S12). Then, the preprocessing command generation unit 33 generates a paper feed command and transmits this command to the buffer 13a (S13). Following the generation of the paper feed command, the dummy command generation unit 34 also generates a dummy command with respect to this paper feed command and transmits the generated dummy command to the buffer 13a (S14). Then, the printing data command generation unit 35 generates a printing data command and transmits this command to the buffer 13a (S15). If the generation of this printing data command is completed, the job end command generation unit 36 generates a job end command, transmits the generated command to the buffer 13a (S16), and ends the series of processing operations.

Thus, if the command generation unit 31 receives the printing command from the AP unit 20 (S10), the job start command, dummy command, paper feed command, dummy command, printing data command, and job end command are transmitted in the order of description to the buffer 13a. Further, from among these commands, the commands that have been prepared in advance can be used as the job start command, dummy command, and job end command. Therefore, the job start command and dummy command can be outputted continuously immediately after the printing command has been received. As for the dummy command following the paper feed command, this dummy command can be outputted continuously immediately after the output of the paper feed command. On the other hand, because the paper feed command is a command for determining the printing start position of the printing paper P and feeding the printing paper P to a position corresponding to the printing start position, the contents of the printing instruction from the AP unit 20 has to be analyzed in the same manner as that relating to the printing data command, and a certain time is required to output these commands.

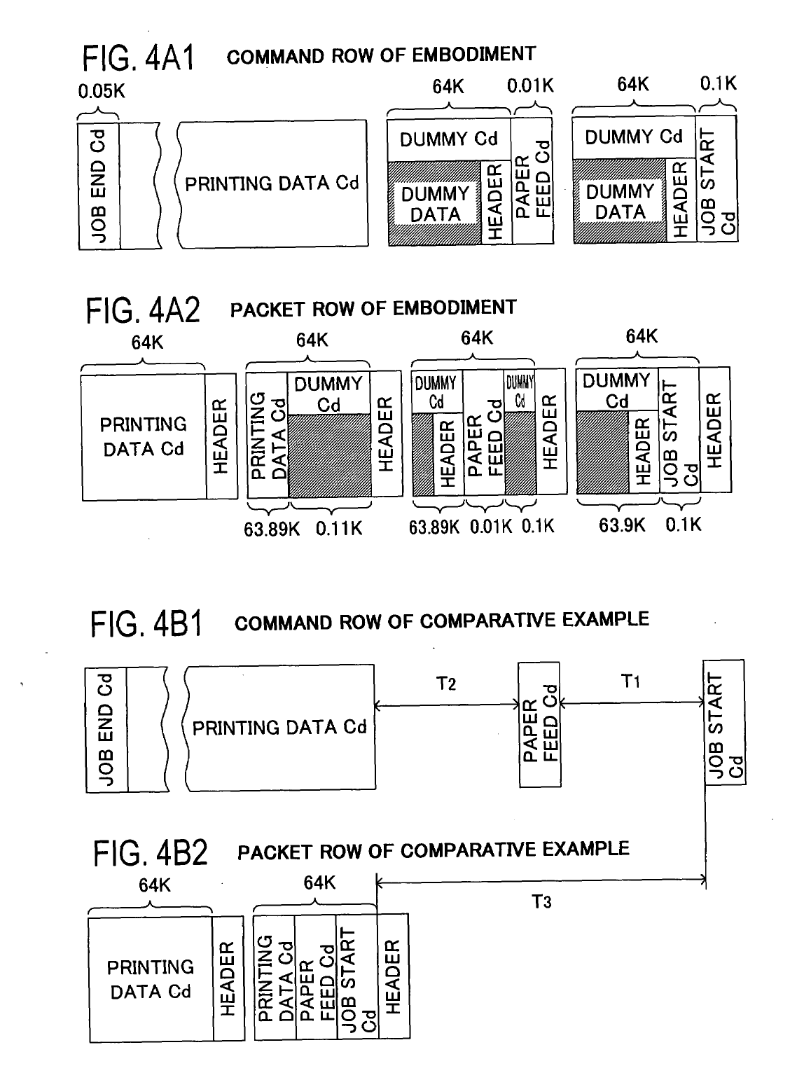

The data length of each command will be explained below by using FIG. 4A1. The data lengths explained herein are merely an example and place no limitation on the present invention.

The data length of the job start command is about 100 B, the data length of the paper feed command is about 10 B, and the data length of the job end command is about 50 B. The data length of the dummy command is 64 KB and equal to the capacity of the buffer 13a. The printing data command is generated for each certain unit volume, such as one line unit, but the data length of the printing data command differs depending on the length of one line or on whether the printing data is image data or text data.

Each command has a header and a payload. The dummy command obviously also has a header and a payload, and the header thereof contains data indicating that the data of the payload are meaningless dummy data and the data length of this dummy data.

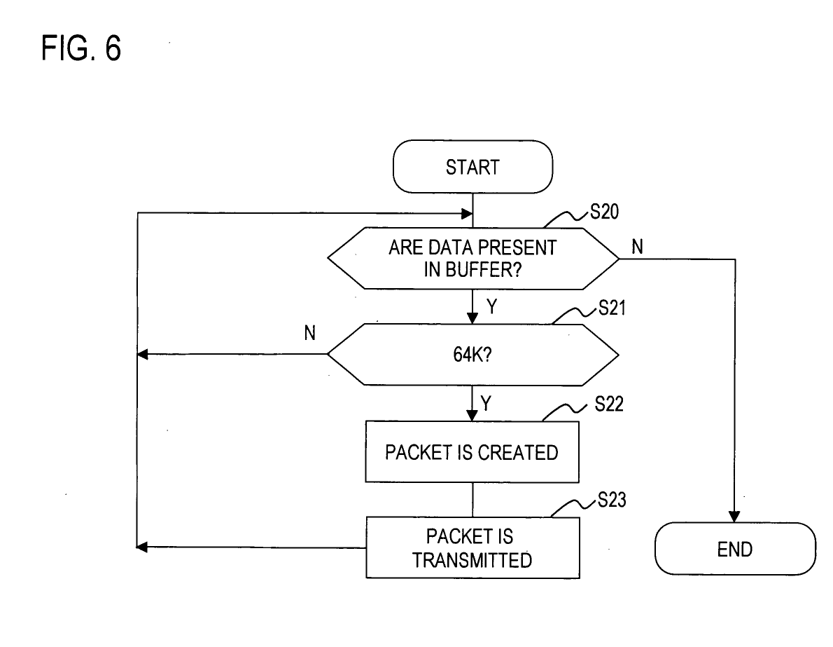

The operation of the command transmission unit 37 of the host computer 10 will be explained below following the flowchart shown in FIG. 6.

The command transmission unit 37 monitors as to whether data are present in the buffer 13a (S20), waits till data are accumulated therein (S21), and if data of 64 KB are accumulated in the buffer 13a, the command transmission unit combines the data into a packet (S22) and transmits the packet to the printer 40 (S23). The processing of step 20 to step 23 is repeated until no data is present in the buffer 13a.

As shown in FIG. 4A2, the packet transmitted from the command transmission unit 37 has a header containing data relating to a transmission source and transmission destination and a payload storing data that actually have to be sent to the transmission destination. The data length of the payload is 64 KB and equal to the capacity of the buffer 13a. Accordingly, a packet containing a job start command of about 100 B (0.1 KB) also contains a dummy command in addition to the job start command. However, because the dummy command is 64 KB, all the dummy data contained in the dummy command cannot be fit into the packet, and the remaining dummy data of 0.1 KB are contained in the next packet. The next packet contains the remaining dummy data of 0.1 KB, a paper feed command of about 10 B (0.01 KB), and a new dummy command. A next packet contains the remaining dummy data contained in the new dummy command and part of the printing command. The following packet contains a printing data command, and the very last packet contains a job end command.

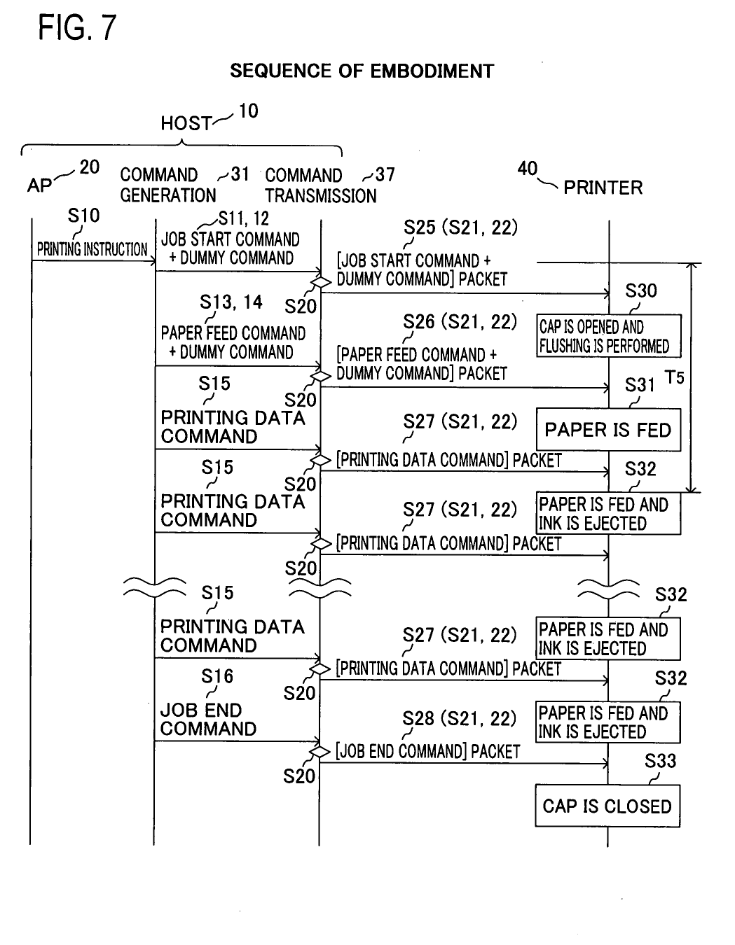

The operation timing of the printer 40 will be explained below following the sequence diagram shown in FIG. 7.

If the command generation unit 31 of the host computer 10 receives a printing command from the AP unit 20 (S10), the command generation unit generates, as described hereinabove, a job start command and a 64 KB dummy command following thereto and transmits the commands to the buffer 13a (S11, 12). If data are accumulated to the capacity of the buffer 13a (S20), the command transmission unit 37 transmits the commands accumulated in the buffer 13a to the printer 40 (S25 (S21, 22)). After the job start command has been stored in the buffer 13a, a 64 KB dummy command matching the capacity of the buffer 13a is immediately stored therein. Therefore, the waiting interval for the command transmission unit 37 from the transmission of the job start command to the buffer 13a to the accumulation of data matching the capacity of the buffer 13a is substantially zero, and the command transmission unit combines the job start command and dummy command into a packet and transmits the packet to the printer 40.

If the printer 40 receives the [job start command+dummy command] packet, the control signal generation unit 48 interprets these commands. In the process of interpreting the commands, the control signal generation unit 48 refers to the information of the dummy command header and discards the dummy command. Then, the control signal generation unit generates a control signal based on the job start command, drives the printing mechanism 50 and executes the preprocessing operations, more specifically a cap opening operation and flushing operation of the printing mechanism 50 (S30).

Following the generation (S11, 12) of the above-descried job start command and dummy command, the command generation unit 31 of the host computer 10 generates the paper feed command and then a 64 KB dummy command and transmits them to the buffer 13a (S13, 14). Similarly to the above-described case, after the paper feed command has been stored in the buffer 13a, a 64 KB dummy command matching the capacity of the buffer 13a is immediately stored therein. Therefore, the waiting interval for the command transmission unit 37 from the transmission of the paper feed start command to the buffer 13a to the accumulation of data matching the capacity of the buffer 13a (S20) is substantially zero, and the command transmission unit 37 combines the paper feed command and dummy command into a packet and transmits the packet to the printer 40 (S26 (S21, 22)).

If the printer 40 receives the [paper feed command+dummy command] packet, the printer discards the dummy command, generates a control signal based on the paper feed command, drives the printing mechanism 50, and executes a paper feed operation (S31). The paper feed operation is an operation of moving the printing start position in the printing paper P to the position of the printing head 55.

Following the generation of the paper feed command and dummy command (S13, 14), the command generation unit 31 of the host computer 10 generates a printing data command and transmits it to the buffer 13a (S15). If the printing data command of a capacity of the buffer 13a is accumulated therein (S20), the command transmission unit 37 converts the printing command accumulated in the buffer 13a into a packet and transmits the packet to the printer 40 (S27 (S21, 22)).

If the printer 40 receives the [printing data command] packet, the printer generates a control signal based on the printing data command, drives the printing mechanism 50, and executes an actual printing operation such as paper feed and ink ejection operations (S32).

Finally, the command generation unit 31 of the host computer 10 generates a job end command and transmits it to the buffer 13a (S16). The command transmission unit 37 converts the job end command accumulated in the buffer 13a into a packet and transmits it to the printer 40 (S28 (S21, 22)).

If the printer 40 receives the [job end command] packet, the printer generates a control signal based on the job end command, drives a printing mechanism 50, and executes, e.g., a cap closing operation of the printing mechanism 50 (S33).

Data transmission from the printer 40 to the host computer 10 has not been described above, but actually if the printing mechanism 50 executes the cap closing operation (S33) and the printing ends, the printing end command is transmitted to the host computer 10.

A comparative example of the present embodiment will be described below to explain the effect of the embodiment.

The printer system of the comparative example is basically identical to the printer system of the embodiment, the difference therebetween being in that the printer system of the comparative example has no dummy command generation unit 34 as a function of the PD unit 30.

As a result, as shown in FIG. 4B1, after the command generation unit of the comparative example generates a job start command, no dummy command is generated, and then a paper feed command is generated and a printing data command is generated thereafter. The paper feed command and printing data command are the commands that are produced based on the printing instruction from the AP unit 20 after this printing instruction has been interpreted as described hereinabove. Therefore, the command generation unit outputs the job start command, then outputs the paper feed command after a fixed interval T₁ elapses, and further outputs the printing data command after a fixed interval T₂ elapses. In other words, the paper feed command and printing data command cannot be outputted continuously, that is, without waiting after the job start command has been outputted. The same is true for the present embodiment.

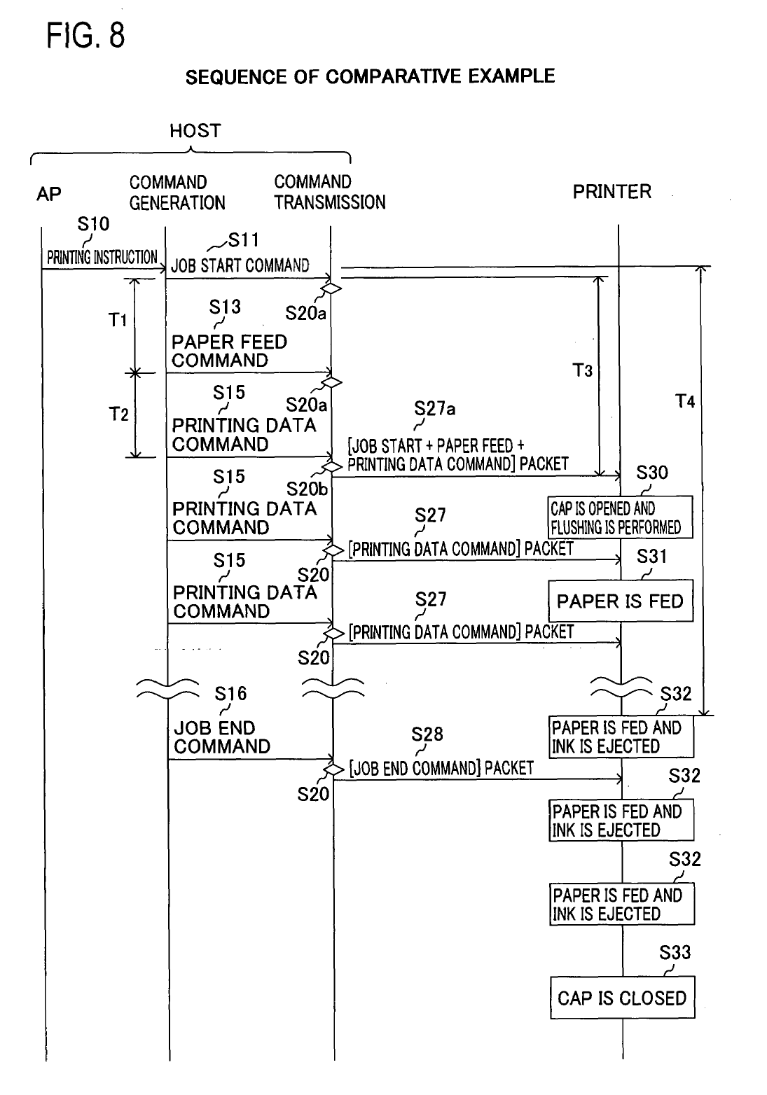

As described above, because the data length of the job start command is about 100 B and the data length of the paper feed command is 10 B, even if the command generation unit generates a job start command and transmits it to the buffer (S11), as described in FIG. 8, the data matching the capacity (64 KB) of the buffer are not accumulated therein.

Therefore, the command transmission unit does not generate immediately a packet containing the job start command (S20a). Furthermore, even if the command generation unit generates the paper feed command and transmits it to the buffer (S13), the command transmission unit does not generate a packet (S20a).

Data matching the capacity of the buffer are accumulated in the buffer for the first time when the command generation unit generates a printing data command and transmits this command to the buffer (S15). The command transmission unit receives indication that the commands matching the capacity of the buffer has accumulated therein (S21b) and combines the commands accumulated in the buffer into a packet. In other words, the job start command, paper feed command, and printing data command are combined into a packet (S27a). For this reason, in the comparative example, an interval T₃ from the output of the job start command from the command generation unit to the transmission of the [job start command+paper feed command+printing data command] packet by the command transmission unit becomes long. As a result, the time from the output of the printing instruction by the AP unit (S10) to the initial operation of the printer (S30), the time to the initial paper feed operation (S31), and also the time T₄ to the actual start of printing operation become long.

By contrast, in the present embodiment, as described with reference to FIG. 7, if the command generation unit 31 generates a job start command (S11), the [job start command] packet is transmitted from command transmission unit 37 substantially without any delay (S25). Therefore, the interval from the output of the printing instruction by the AP unit 20 (S10) to the initial operation of the printer 40 (S30) is much shorter than that in the comparative example. Furthermore, if the command generation unit 31 generates a paper feed command (S13), the [paper feed command] packet is transmitted from command transmission unit 37 substantially without any delay (S26). Therefore, the interval from the generation of the paper feed command by the command generation unit 31 to the transmission of the [paper feed command] packet is also much shorter than that in the comparative example. As a result, the time from the output of the printing instruction by the AP unit 20 (S10) to the initial operation of the printer 40 (S30), the time to the initial paper feed operation (S31), and also the time T₅ to the actual start of printing operation (S32) are much shorter than those in the comparative example.

As described hereinabove, in the present embodiment, the interval from the output of a printing instruction by the AP unit 20 of the host computer 10, in other words, from the transmission of a printing start instruction by the user to the host computer 10, to the start of the actual printing operation by the printer 40 can be greatly shortened.

The present invention is not limited to the above-described embodiment, and it goes without saying that the present invention can be implemented in a variety of modes, provided that they are included in the technical scope of the invention.

For example, in the present embodiment, the dummy command was generated following the generation of the paper feed command, but a process in which no such dummy command is generated is also possible, and in this case, the interval from the printing instruction output to the actual printing operation start is still shorter than that in the comparative example. However, it goes without saying that when the dummy command is generated following the generation of the paper feed command, as in the present embodiment, the interval from the printing instruction output to the actual printing operation start is shorter.

Further, in the present embodiment, the data length of the dummy command, strictly speaking the command length, was 64 KB and equal to the capacity of the buffer 13a, but the command length is not limited to this size and may be from 1 byte to the size of the packet transmitted by the command transmission unit 37. For example, it can be 32 KB. When the command length is 32 KB, one packet is configured of a job start command and two dummy commands and transmitted to the printer 40.

If the packet comprising the job start command and the packet comprising the paper feed command are filled up with the dummy command of a size within the aforementioned range, the number of dummy commands that are discarded in the printer 40 that receives such packets is not increased. Therefore, the dummy command discarded interval of the printer 40 is short and a sufficient effect of making the aforementioned printing operation start earlier can be obtained. When the dummy command has a size below the aforementioned range and the packet, e.g., of a job start command has to be filled up with a large number of dummy commands, the dummy command discarded interval in the printer 40 increases and the above-described effect is not produced.

Further, the command length of a dummy command may be the difference between a packet size and a job start command and a difference between a packet size and a paper feed command. When the data length of the job start command is 0.1 KB, as described above, the command length of the dummy command supplied after the job start command can be 63.9 KB, and when the data length of the paper feed command is 0.01 KB, the command length of the dummy command supplied after the paper feed command can be 63.99 KB. As a result, each dummy command is completed when a packet is received by the printer 40. Therefore, the commands can be immediately discarded and it is not necessary to wait for the arrival of the next packet.

What is claimed is:

1. A computer readable medium recording a printer control program for executing in a computer a command generation of generating a command that instructs a printer on operation and a command transmission of converting a command containing a predetermined amount of data into a packet and transmitting the packet command, wherein the computer executes:
generating a preprocessing command for actuating a printing mechanism before a coloring agent is attached to a printing medium, and
generating a dummy command to be included in a packet so as to obtain the predetermined amount of data, which will be discarded by the printer, and
generating one or more packets including the dummy command and the preprocessing command.

2. The computer readable medium according to claim 1, wherein the computer executes:
generating the dummy command with a command length from 1 byte to the packet length.

3. A printer control method having a command generation of generating a command that instructs a printer on operation and a command transmission of converting a command containing a predetermined amount of data into a packet and transmitting the packet command, wherein the method comprising:
generating a preprocessing command for actuating a printing mechanism before a coloring agent is attached to a printing medium, and
generating a dummy command to be included in a packet so as to obtain the predetermined amount of data, which will be discarded by the printer, and
generating one or more packets including the dummy command and the preprocessing command.

4. The printer control method according to claim 3,
generating the dummy command with a command length from 1 byte to the packet length.

5. A command processing system that processes a command used for a printing unit comprising:
a command generation portion which generates the command that instructs the printing unit on operation;
a storage portion which stores the command generated by the command generation portion;
a command transmission portion which converts a command containing a predetermined amount of data into a packet and transmitting the packet command;
wherein the command generation portion has a preprocessing command generation portion which generates a preprocessing command that actuates a printing mechanism before a coloring agent is attached to a printing medium and outputting the preprocessing command to the storage portion, and a dummy command generation portion which generates a dummy command to be included in a packet so as to obtain the predetermined amount of data, which will be discarded by the printing unit and outputting the dummy command to the storage portion.

6. The command processing system according to claim 5, wherein the dummy command generation portion generates the dummy command with a command length from 1 byte to the packet length.

7. The command processing system according to claim 5, wherein the preprocessing command causes the printing unit at least one of a cap opening operation and a flushing operation and a paper feed operation.

8. The command processing system according to claim 5, wherein the command transmission portion converts both of the dummy command and the preprocessing command into a packet.

9. The command processing system according to claim 5, wherein the dummy command generation portion output the dummy command subsequently to the preprocessing command to the storage portion if the preprocessing command generation portion generates the preprocessing command.

10. The command processing system according to claim 5, further comprising:
a command reception portion which receives a command from the command transmission portion;
a control signal generation portion which interprets the command received by the command reception portion and generates a control signal corresponding to the interpretation results to the printing unit;
wherein the control signal generation portion discards the dummy command when the dummy command is contained in the command received by the command reception portion.
